(19) United States
(12) Patent Application Publication
(10) Pub. No.: US 2006/0026318 A1
(43) Pub. Date: Feb. 2, 2006

(54) Apparatus, medium, and method controlling audio/video output

(75) Inventor: Kyung-hee Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/189,805

(22) Filed: Jul. 27, 2005

(30) Foreign Application Priority Data
Jul. 30, 2004 (KR) 10-2004-0060260

(51) Int. Cl. G06F 13/38

(52) U.S. Cl. 710/72; 710/62

(57) ABSTRACT

An apparatus, medium, and method controlling an audio output and/or a video output. The apparatus includes an input device interface module for receiving content including video information and audio information corresponding to the video information, a user interface module for providing a user interface to enable a user to select an output device for receipt of the audio information and an output device for receipt of the video information, a control module for receiving the content from the input device interface module and outputting to an output device interface module a command to transmit one of the audio information and/or the video information, and the output device interface module for receiving the command from the control module and transmitting one of the audio information and/or the video information to each selected output devices.

### CROSS-REFERENCE TO RELATED APPLICATIONS

This application claims priority from Korean Patent Application No. 10-2004-0060260 filed on Jul. 30, 2004 in the Korean Intellectual Property Office, the disclosure of which is incorporated herein by reference in its entirety.

### BACKGROUND OF THE INVENTION

1. Field of the Invention

Embodiments of the present invention relate to apparatuses, media, and methods controlling audio output and/or video output, and more particularly, to an apparatus, medium, and method transmitting desired video and/or audio information to output devices when a user plays content including the video and/or audio information.

2. Description of the Related Art

When a user wants to view content including video and audio, e.g., a movie stored in a digital video disc (DVD), the user can insert the DVD into the DVD drive of a notebook computer and execute an application program for video playback. Then, the video is displayed on a liquid crystal display (LCD) screen of the notebook computer and the audio is output to an internal speaker in the notebook computer or an external speaker connected to the notebook computer. However, when the user wants to view the movie on a high-quality digital television (TV) such as a high-definition TV (HDTV), as shown in FIG. 1, video output 120 is sent to a video input terminal of the HDTV through a video cable 110, and audio output 140 is sent to an audio input terminal of the HDTV through an audio cable 130. In other words, a video output and an audio output are transmitted to the HDTV via separate transmission media.

Video and audio output is conventionally transmitted via cables to devices such as HDTVs. Similarly, when a DVD is played on a desktop personal computer (PC) equipped with a DVD drive, audio may be output through an external speaker connected to the desktop PC and video may be output to a projector connected to the desktop PC, for example.

Recently, however, diverse display devices and audio output devices have been introduced, and users have increasingly desired to view content such as movies through these devices with more convenient methods. In other words, a method is desired that allows a user to select a plurality of output devices through a single user interface and separately output video and audio to these devices.

In addition, when video and audio information are transmitted to a high-quality digital TV such as a HDTV, as shown in FIG. 1, separate cables need to be used, which is inconvenient and decreases spatial efficiency. Accordingly, there is a desire to transmit video and audio information through a single cable. When a plurality of output devices are connected, electrical power must be continuously supplied even to output devices that are not selected by the user. As such, there is a further desire for a method to conserve power by cutting the power supply to the output devices that are not selected by the user or by controlling power supplied to an integrated circuit (IC) chip set that controls the video and audio output. The present invention includes these above desires and correspondingly sets forth solutions for the same.

### SUMMARY OF THE INVENTION

Embodiments of the present invention set forth a single user interface enabling a user to select a plurality of output devices and enabling video and/or audio to be separately output to the selected output devices, respectively.

In addition, embodiments of the present invention also set forth a method of transmitting video information and/or audio information to a particular video output device through a single cable.

Further, embodiments of the present invention also set forth a method of saving electrical power supplied to a plurality of output devices by sensing a connection or disconnection of a cable.

To achieve the above and/or other aspects and advantages, embodiments of the present invention include an apparatus controlling an audio output and/or a video output, including an input device interface module to receive content including video information and audio information corresponding to the video information, a user interface module to provide a user interface to enable a user to select at least one output device for receipt of the audio information and at least one output device for receipt of the video information, and to enable a user to select the at least one output device for receipt of the audio information or the at least one output device for receipt of the video information, a control module to receive the content from the input device interface module and output to an output device interface module a command to transmit the audio information and/or the video information to a respective selected output device, and an output device interface module to receive the command from the control module and transmit the audio information and/or the video information to each selected output devices, respectively.

The output device interface module may transmit state information of output devices to the control module, the control module transmit the state information to the user interface module, and the user interface module may display output devices that can be selected by the user in the user interface.

The apparatus may further include a storage module to store mapping information between output devices for outputting the video information and output devices for outputting the audio information, wherein the control module extracts mapping information corresponding to the at least one output device selected by the user from the storage module and outputs a command corresponding to the extracted mapping information.

In addition, the at least one output device for receipt of the video information includes a digital display device that receives the video information and the audio information from the output device interface module via a single cable. The cable may be a medium supporting a high definition multimedia interface (HDMI) standard. Further, the digital display device may include an integrated circuit chipset supporting the HDMI standard, and electrical power supplied to the integrated circuit chipset is interrupted when the integrated circuit chipset does not receive video and/or audio information via the cable for a predetermined period of time. Similarly, the digital display device may include an integrated circuit chipset supporting the HDMI standard, and electrical power supplied to the digital display device is interrupted when the integrated circuit chipset does not receive any video and/or audio information via the cable for a predetermined period of time.

The output device interface module may be in an off-state in an initial start-up stage of the apparatus. The output device interface module may be turned on when the apparatus senses that the output device interface module has been connected with any output device via a cable. Further, the output device interface module may sense the connection with the output device via the cable based on a change in a resistance value which occurs when the cable is connected to the output device interface module. The output device interface module may supports a high definition multimedia interface (HDMI) standard.

To achieve the above and/or other aspects and advantages, embodiments of the present invention include a method of controlling an audio output and/or a video output, including receiving content including video information and audio information corresponding to the video information, providing a user interface including a first section including a list of audio output devices to enable at least one audio output device for receipt of the audio information to be selected, a second section including a list of video output devices to enable at least one video output device for receipt of the video information to be selected, and a third section including a control input to enable initiation of the audio information to be transmitted to the selected audio output device and to enable initiation of the video information to be transmitted to the selected video output device, enabling a user to select the at least one audio output device in the first section, enabling the user to select the at least one video output device in the second section, and transmitting the audio information to the at least one selected audio output device and/or the video information to the at least one selected video output device.

The audio output device may be enabled to be selected in the first section when the audio output device is connected to the apparatus and is in a state enabling receipt of the audio information. Similarly, the video output device may be enabled to be selected in the second section when the video output device is connected to the apparatus and is in a state enabling receipt of the video information. In addition, the video output device enabled to be selected in the second section may be compatible with a previously selected video output device and can receive the video information. The video output device may include a high definition digital television.

In addition, the second section may include a list of video output devices to enable the at least one video output device to be selected.

To achieve the above and/or other aspects and advantages, embodiments of the present invention include an method for controlling an audio output and/or a video output, including receiving content including video information and audio information corresponding to the video information, enabling a user to select at least one output device for receipt of the audio information and at least one output device for receipt of the video information, and enabling a user to select at the least one output device for receipt of the audio information or the at least one output device for receipt of the video information, and transmitting the audio information and/or the video information to each selected output devices, respectively.

To achieve the above and/or other aspects and advantages, embodiments of the present invention include a system controlling an audio output and/or a video output, including an input device interface module to receive content including video information and audio information corresponding to the video information, a plurality of output devices to display the video information and/or audibly reproduce the audio information, a user interface module to provide a user interface to enable a user to select at least one output device, of the plurality of output devices, for receipt of the audio information and at least one output device, of the plurality of output devices, for receipt of the video information, and to enable a user to select the at least one output device for receipt of the audio information or the at least one output device for receipt of the video information, a control module to receive the content from the input device interface module and output to an output device interface module a command to transmit the audio information and/or the video information to a respective selected output device, and an output device interface module to receive the command from the control module and transmit the audio information and/or the video information to each selected output devices, respectively.

The at least one output device for receipt of the audio information and the at least one output device for receipt of the video information may be the same output device.

In addition, the at least one output device for receipt of the audio information and/or the at least one output device for receipt of the video information may be physically separate from the user interface module.

To achieve the above and/or other aspects and advantages, embodiments of the present invention include at least one medium including computer instructions implementing embodiments of the present invention.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional method of transmitting video information and audio information to another system;

FIG. 2 is a block diagram of an apparatus for controlling a video output and/or an audio output, according to an embodiment of the present invention;

FIG. 3 illustrates a user interface for control of a video output and/or an audio output, according to an embodiment of the present invention;

FIG. 4 is a block diagram of a structure for transmitting video information and/or audio information through a single cable, according to an embodiment of the present invention;

FIGS. 5A through 5C illustrate structures of data packets including video information and/or audio information, according to an embodiment of the present invention;

FIG. 6 is a block diagram of a structure for transmitting video information to a plurality of display devices using a plurality of graphic controllers, according to an embodiment of the present invention;

FIG. 7 is a flowchart of a method of controlling a video output and/or an audio output, according to an embodiment of the present invention; and

FIGS. 8A and 8B illustrate the example of a cable used to transmit video information and audio information according to an embodiment of the present invention.

### DETAILED DESCRIPTION OF THE PREFERRED EMBODIMENTS

Advantages and features of the present invention may be understood more readily by reference to the following detailed description of embodiments and the accompanying drawings. Like reference numerals refer to like elements throughout the specification.

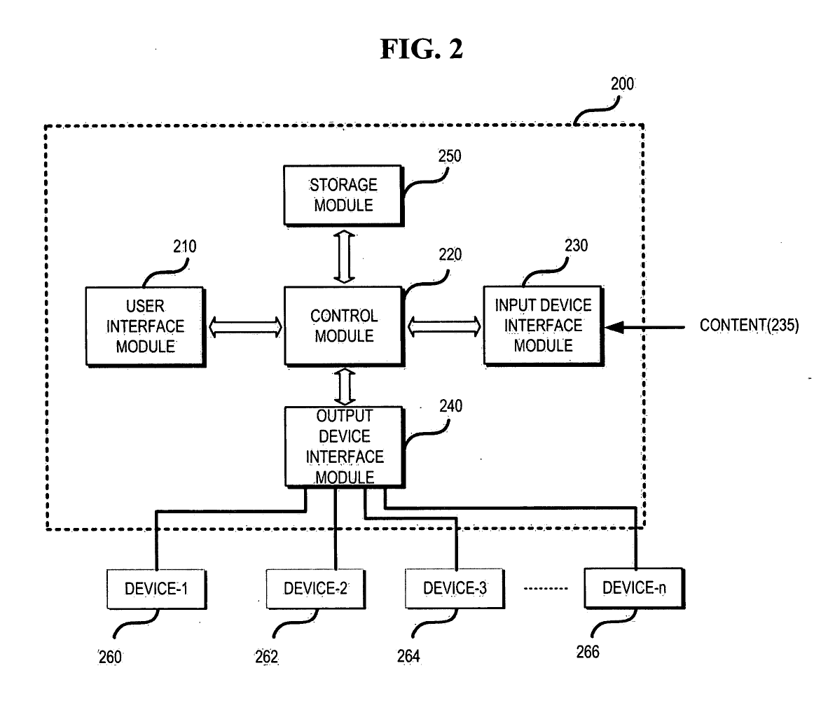

FIG. 2 illustrates a block diagram of an apparatus 200 controlling video and/or audio output, according to an embodiment of the present invention. The apparatus 200 can include an input device interface module 230, a user interface module 210, a control module 220, an output device interface module 240, and a storage module 250.

It is noted that the term ‘module’, as used herein, corresponds to, but is not limited to, a computer instruction, e.g., software, or hardware component, such as a Field Programmable Gate Array (FPGA) or an Application Specific Integrated Circuit (ASIC), which performs certain tasks, for example. A module may advantageously be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

The input device interface module 230 receives content including video and/or audio information (hereinafter, referred to as just “content”).

The user interface module 210 can provide a user interface enabling a user to select a device that outputs audio information (hereinafter, referred to as an audio output device) and/or a device that outputs video information (hereinafter, referred to as a video output device). The control module 220 can receive content from the input device interface module 230 and output a command for transmitting the audio information and/or the video information to the selected device. The output device interface module 240 can receive the command from the control module 220 and output the audio information and/or the video information to the selected device. Here, the output device interface module 240 may also include a device management module (not shown) controlling or monitoring a device. There may be as many device management modules as connected devices. The storage module 250 may also store information mapping the video output device and the audio output device.

The following describes in detail interactions between modules of the apparatus 200.

For simplification, the following discussion will be based on an assumption that the apparatus 200 is a notebook computer, noting that embodiments of the present invention are not limited thereto.

A user may insert a digital video disc (DVD), for example, containing content 235, such as a movie, into a DVD drive. Here, the DVD drive may be an internal or an external drive, and the input device interface module 230 may manage the DVD drive.

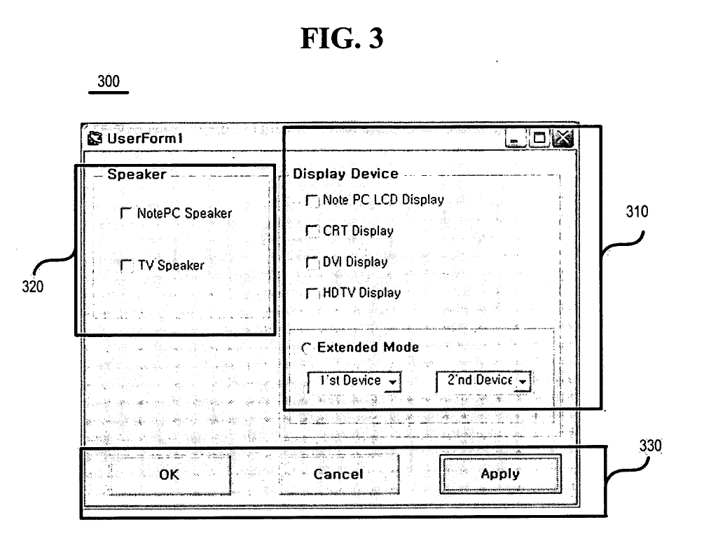

The input device interface module 230 can transmit a message indicating that the content 235 has been received to the control module 220. Then, the control module 220 can manage the user interface 210 to produce a user interface enabling the user to select a video output device and/or an audio output device. Alternatively, the user interface may be initiated directly by the user. FIG. 3 illustrates an example of the user interface.

Referring to FIG. 3, a user interface 300 can include a first section 320 including a list of audio output devices to enable at least one audio output device to be selected, a second section 310 including a list of video output devices to enable at least one video output device to be selected, and a third section 330 including a control input for managing the audio and video transmissions. Preferably, the third section 330 may include an “Apply” button for executing a command to transmit audio information and/or video information to an output device selected by the user, a “Cancel” button for canceling the user's selection, and/or an “Exit” button for terminating the user interface 300, noting that embodiments of the present invention are not limited thereto.

Meanwhile, the output device interface module 240 can monitor the connection states of exemplary output devices 260, 262, 264, and/or 266, which may be video and/or audio output devices, and reports the connection states to the control module 220. The control module 220 can receive connection state information from the output device interface module 240 and transmit it to the user interface module 210, and then the user interface module 210 can reflect the connection state information in the user interface. For example, when a digital video interface (DVI) display device and a cathode ray tube (CRT) display device are not connected or are in a power-off state, “CRT Display” and “DVI Display” in the second section 310 could be disabled so that the user cannot select them. In addition, when an HDTV is not connected or when a connected TV does not have an audio unit, a “TV Speaker” check box may also be disabled, for example.

When the user interface 300 is provided to a user, the user can select an audio output device in the first section 320 and a video output device in the second section 310. In the second section 310, for example, an operation of transmitting a single image to two video output devices may be provided. In detail, when a “Select extension mode” check box, for example, is selected in the second section 310, “LCD Display,” “CRT Display”, “DVI Display”, and “HDTV Display” can be disabled so that the user cannot select them. The user can select video output devices in a “Primary selection” box and a “Secondary selection” box. Thereafter, if the user clicks on the “Apply” button in the third section 330, a video image can be output to the output device selected in the “Primary selection” box and the output device selected in the “Secondary selection” box.

For example, when a user selects a “Notebook PC Speaker” in the first section 320 and the “Note PC LCD Display” and the “HDTV Display” in the second section 310 and then clicks on the “Apply” button in the third section 330 on the user interface 300 shown in FIG. 3, the user interface module 210 receives user selection information and transmits it to the control module 220.

Here, the control module 220 can control the output device interface module 240 to drive device management modules that drive a speaker of the notebook computer 200, an LCD screen of the notebook computer 200, and an HDTV screen, for example. Thereafter, the control module 220 can split the audio information and video information of the content 235, received from the input device interface module 230, and transmit the split audio and video information to the output device interface module 240. Then, the output device interface module 240 can transmit the audio information to the speaker of the notebook computer 200, and transmit the video information to the LCD screen of the notebook computer 200 and the HDTV screen.

Meanwhile, as noted above, the control module 220 may use mapping information between video output devices and audio output devices, which can be stored in the storage module 250, to transmit the user selection information to the output device interface module 240. In detail, when the storage module 250 manages and stores both possible combinations between the audio output devices displayed in the first section 320 of the user interface 300 and the video output devices displayed in the second section 310 thereof and code information regarding each combination in a table form, for example, the control module 220 may extract relevant code information from the storage module 250 based on the user selection information received from the user interface module 210 and transmit the code information to the output device interface module 240. Then, the output device interface module 240 may drive relevant device management modules based on the code information.

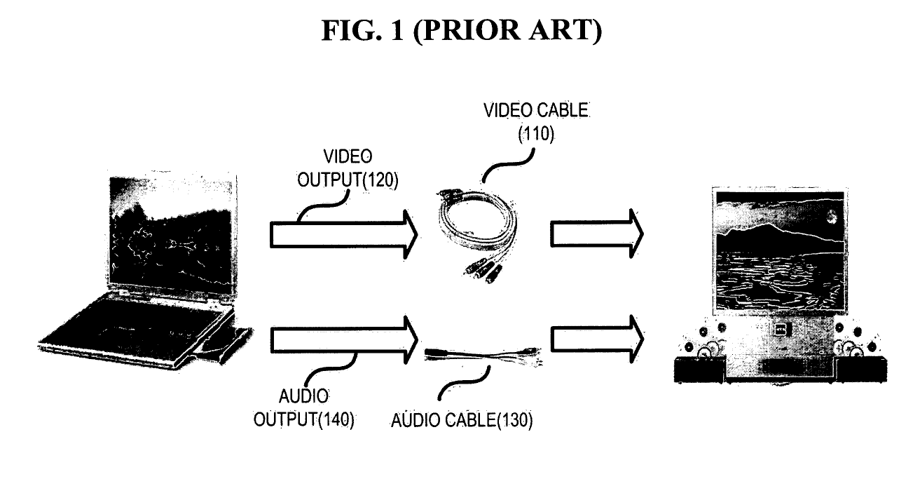

As shown in the conventional diagram of FIG. 1, the video output 120 and the audio output 140 are sent to different output devices via different cables. However, when a user outputs both audio and video to an HDTV, using different cables as shown in FIG. 1, the use of different cables is inconvenient and reduces spatial efficiency. Accordingly, a transmission medium capable of transmitting digital audio information and digital video information together would be desirable. A high definition multimedia interface (HDMI) standard provides such transmission. HDMI cables and HDMI chipsets have been developed according to the HDMI standard. The detailed description of HDMI can be found at www.hdmi.org.

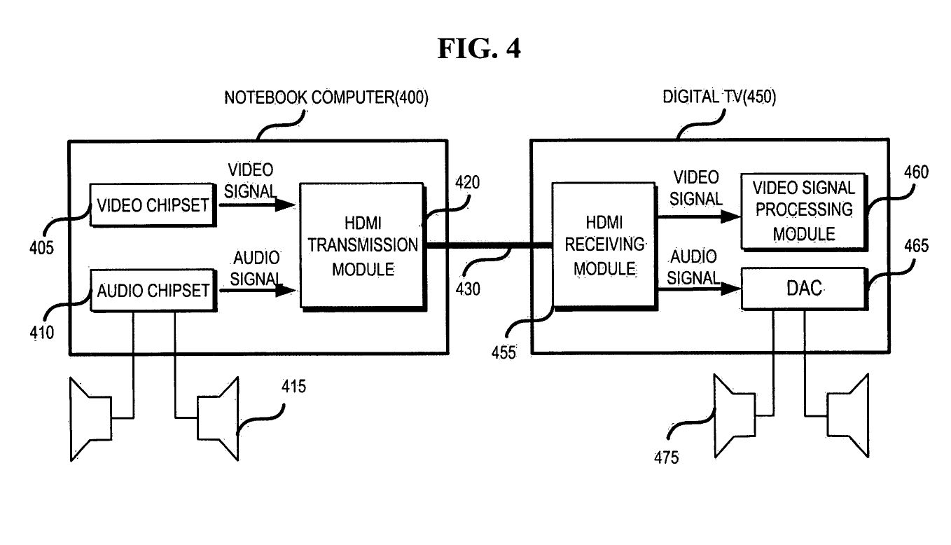

The HDMI standard can be applied to the notebook computer 200, according to an embodiment of the present invention. Accordingly, FIG. 4 illustrates a structure for transmitting video information and audio information via a single cable, according to an embodiment of the present invention.

The notebook computer 400, corresponding to the apparatus 200 for controlling a video output and an audio output, according to an embodiment of the present invention, may be connected via an HDMI cable 430 to a digital TV 450 including both a video output device and an audio output device.

The notebook computer 400 can include a video chipset 405 and an audio chipset 410, and a video signal output from the video chipset 405 and/or an audio signal output from the audio chipset 410 can be transmitted to an HDMI transmission module 420.

The HDMI transmission module 420 can transmit the video signal and/or the audio signal to an HDMI receiving module 455 via the HDMI cable 430.

The HDMI receiving module 455 can then transmit the received video signal to a video signal processing module 460, to output video to the digital TV 450 screen. In addition, the HDMI receiving module 455 can also transmit the received audio signal to a digital-to-analog converter (DAC) 465. Since the audio signal received by the HDMI receiving module 455 is a digital signal, the DAC 465 may be needed to convert the audio signal to an analog signal. The DAC 465 can then output the analog signal to a speaker 475 connected to the digital TV 450.

It may be necessary to supply electrical power to the HDMI transmission module 420 and the HDMI receiving module 455. However, when using the notebook computer 400, since power saving is important, it may also be necessary to turn off power when neither an audio signal nor a video signal is being sent to the digital TV 450. Accordingly, at an initial stage, no electrical power may be supplied to the HDMI transmission module 420. Instead, the control module 220 can monitor a resistance value, for example, of a portion connected with the HDMI cable 430 and supply electrical power to the HDMI transmission module 420 only when receiving an interrupt signal indicating that the resistance has changed due to the connection of the HDMI cable 430, which would thereby prevent unnecessary power consumption.

In the digital TV 450, electrical power can be supplied to the HDMI receiving module 455 at an initial stage. However, when the HDMI receiving module 455 does not receive either an audio signal or a video signal from the HDMI cable 430 for a predetermined period of time, the supply of electrical power to the HDMI receiving module 455 may be stopped. If neither an audio signal nor a video signal is received for another predetermined period of time, supply of the electrical power to the digital TV 450 may also be stopped. For this operation, a module for sensing receipt of a signal from the HDMI cable 430, or a counter, for example, may be provided within the digital TV 450 or the HDMI receiving module 455.

In addition, a user may also view video using the digital TV 450 while outputting audio to a speaker connected to the notebook computer 400, not to the digital TV 450, even when the notebook computer 400 and the digital TV 450 are connected via the HDMI cable 430. In this situation, the HDMI receiving module 455 may determine where to output audio and video signals based on a packet received from the HDMI transmission module 420, for example.

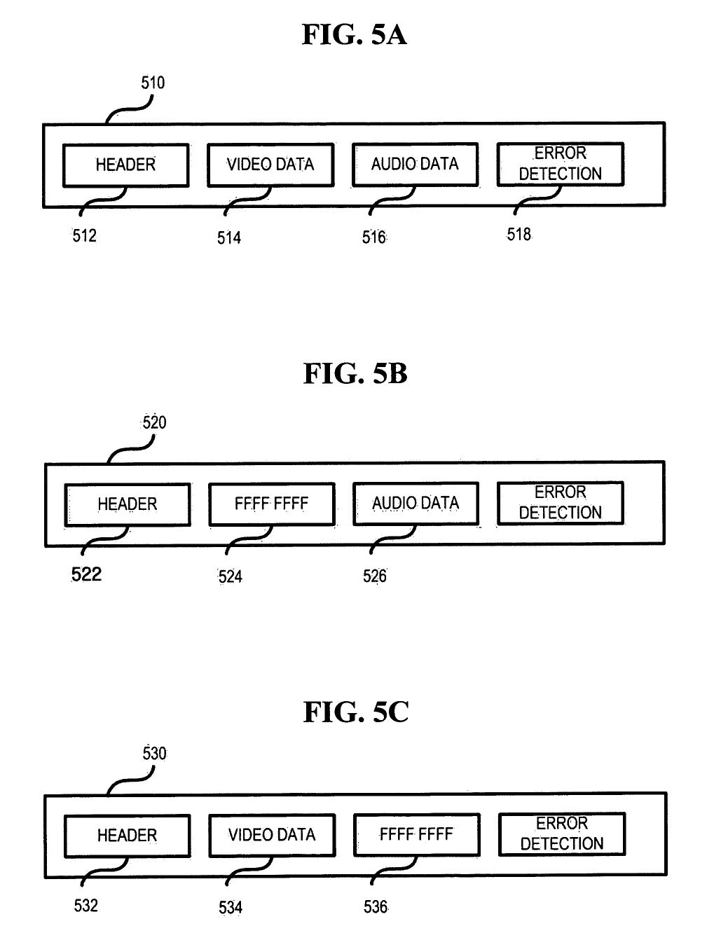

FIG. 5A illustrates a potential structure for a packet 510, which may include a header area 512, a video data area 514, an audio data area 516, and an error detection area 518, for example.

The header area 512 can indicate a beginning of the packet 510 or may include identification information of the packet 510, the video data area 514 and the audio data area 516 may include video data information and audio data information, respectively, and the error detection area 518 may include information for inspecting whether the packet 510 has been corrupted during transmission. Here, a conventional packet error detection method may be used to detect an error.

FIG. 5B illustrates a structure of a packet 520 that could be used to output only audio in the digital TV 450. Here, a video data area 524 of the packet 520 may be set to a binary value of “1”. In this case, the HDMI receiving module 455 can extract only audio data information from an audio data area 526 and output the extracted audio data to the speaker 475 via the DAC 465. The video data area 524 may then be set to a predetermined dummy value other than “1”.

FIG. 5C illustrates a structure of a packet 530 that could be used to output only video in the digital TV 450. Here, an audio data area 536 of the packet 530 may be set to the binary value of “1”. In this case, the HDMI receiving module 455 can extract only video data information from a video data area 534 and outputs the extracted video data to a screen of the digital TV 450 via the DAC 465. The audio data area 536 may similarly be set to a predetermined dummy value other than “1”.

Alternatively, in another embodiment, a particular bit may be set in the header area 522 or 532 to inform the HDMI receiving module 455 which of a video output and/or audio output is to be enabled. For example, two bits may be allocated to the header area 522. To indicate that video output is enabled a first bit can be set to “1”, and when audio output is enabled a second bit may be set to “1”. Accordingly, the two bits could be set to “11” to enable both video and audio output, to “10” to enable only video output, and to “01” to enable only audio output. Here, when only one output is enabled, a data area corresponding to the disabled output may be set to a predetermined dummy value.

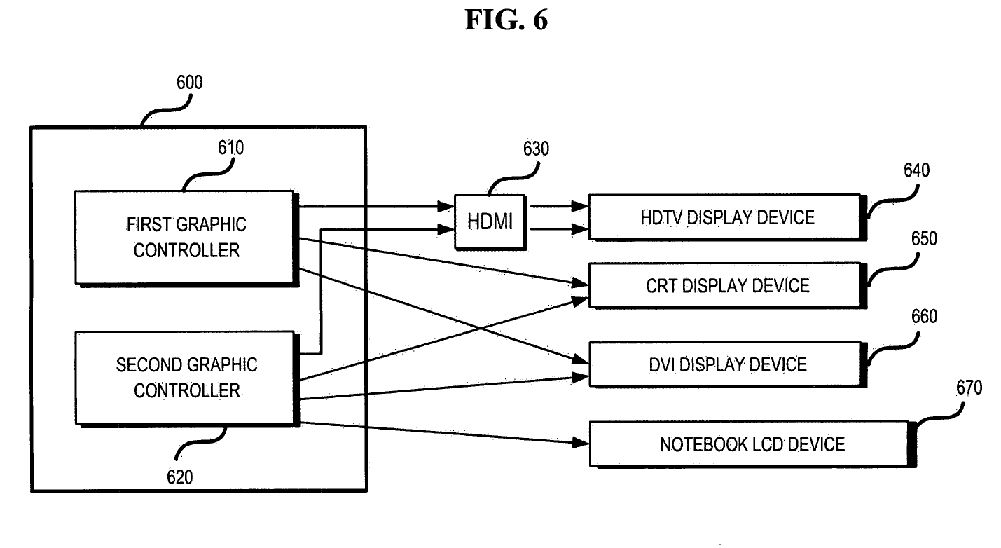

FIG. 6 illustrates a block diagram of a structure for transmitting video information to a plurality of display devices using a plurality of graphic controllers, according to an embodiment of the present invention.

In the case of a notebook computer, a graphic chip 600 may include two graphic controllers, e.g., a first graphic controller 610 and a second graphic controller 620, as shown in FIG. 6. Video output devices can be selected according to information allocated to each of the graphic controllers 610 and 620.

For example, this information could include 4 bits to indicate any one of an exemplary HDTV display device 640, a CRT display device 650, a DVI display device 660, or a notebook LCD device 670. As an example, if the first graphic controller 610 is set to “1000” and the second graphic controller 620 is set to “0001”, the first graphic controller 610 may output video to an HDTV display device 640 via an HDMI 630, and the second graphic controller 620 may output video to the notebook LCD device 670.

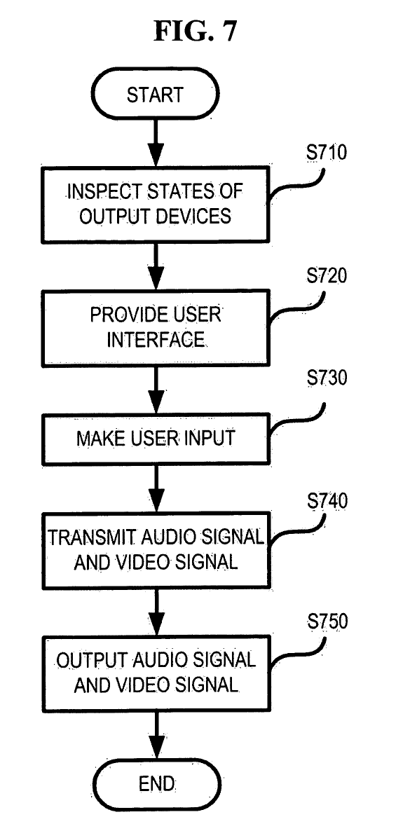

A procedure for outputting a video signal to a plurality of video output devices using the structure illustrated in FIG. 6 will now be described in greater detail, with reference to FIGS. 2 and 3 and the flowchart shown in FIG. 7.

When the user interface 300 is initiated, the output device interface module 240 may inspect the states of output devices, in operation S710. The user interface module 210 may then present the user interface 300 to a user, in operation S720. Here, for example, check boxes of unconnected output devices may be disabled so that the user cannot select unconnected output devices.

The user can select an audio output device in the first section 320 and a video output device in the second section 310, in operation S730. Here, in the following discussion, it will be assumed that all of the output devices displayed on the user interface 300 have been connected.

Information regarding the selected audio output device can be transmitted to the control module 220 via the user interface module 210 and the control module 220 can control the output device interface module 240 to output an audio signal to the selected audio output device, in operations S740 and S750.

In addition, if the user selects two video output devices, the control module 220 can allocate information regarding the video output devices to both the graphic controllers 610 and 620, and both the graphic controllers 610 and 620 can output video signals to the corresponding video output devices based on the allocated information, in operations S740 and S750.

If the user selects three video output devices, the control module 220 could dynamically allocate information regarding the selected video output devices so that the first graphic controller 610 controls two of the selected video output devices and the second graphic controller 620 controls the remaining one, for example. Here, information regarding possible combinations of two video output devices with another video output device can be stored in the storage module 250, and the control module 220 can perform the allocation based on the information stored in the storage module 250. The graphic controllers 610 and 620 can then output the video signal to the corresponding video output devices based on the information regarding the video output devices allocated thereto.

When the HDMI transmission module 420 and the HDMI receiving module 455, shown in FIG. 4, are used, a power saving method for the notebook computer 400 and the digital TV 450 can also be applied.

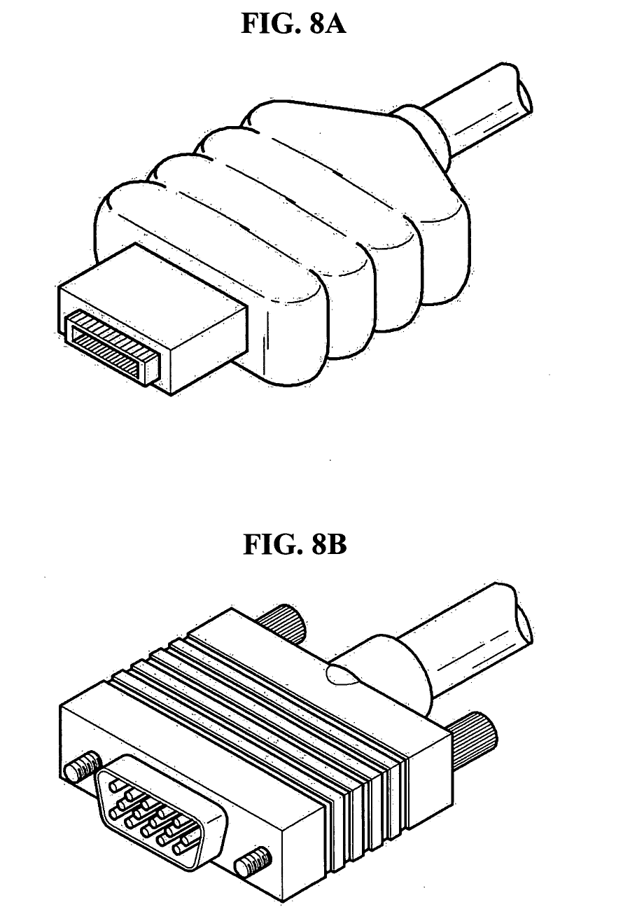

FIG. 8A illustrates an end of an HDMI cable, which can be used to connect to the notebook computer 400, and FIG. 8B illustrates another other end of the HDMI cable, which can connects to the digital TV 450, for example.

First, a power saving method of the HDMI transmission module 420 will now be described. When electrical power is supplied to the notebook computer 400, information regarding the HDMI transmission module 420 can be initialized and loaded during a power on self test (POST), noting that the HDMI transmission module 420 may be off when the operating system of the notebook computer 400 loads. Thereafter, when the HDMI cable 430 is connected to the HDMI transmission module 420, a resistance value at the connection may change. Based on this change, the connection of the HDMI cable 430 can be sensed and electrical power can be supplied to the HDMI transmission module 420.

When the HDMI receiving module 455 receives neither an audio signal nor a video signal via the HDMI cable 430, for a predetermined period of time, electrical power supplied to the HDMI receiving module 455 may be terminated. Thereafter, if neither audio nor a video signals are received for another predetermined period of time, for example, electrical power supplied to the digital TV 450 can be terminated. In other words, when there are no video and audio signals received via the HDMI cable 430, the HDMI receiving module 455 and the digital TV 450 can be turned off in sequence. For this operation, a module sensing a signal received from the HDMI cable 430, or a counter, may be provided within the digital TV 450 or the HDMI receiving module 455, for example.

As described above, embodiments of the present invention allow a user to easily select diverse video and audio output devices for viewing and listening to content such as movies.

As such, the high definition multimedia interface (HDMI) standard is user friendly. Also, power consumption can be reduced by sensing the connection or disconnection of the cable.

Thus, embodiments of the present invention may be embodied in many different forms and should not be construed as being limited to the embodiments set forth above. Rather, these embodiments have been provided so that this disclosure will be thorough and complete and will fully convey the concept of the invention to those skilled in the art, noting that the present invention will only be defined by the appended claims.

In the above referenced block diagrams and flowchart illustrations it should be understood that each block of the illustrations, including combinations of blocks in the flowchart illustrations, for example, can be implemented by computer instructions. These computer instructions can be provided to a processor of a general purpose computer, special purpose computer, or other programmable data processing apparatuses to produce a machine, such that the instructions, which execute via the processor(s) of the computer or other programmable data processing apparatus, implement the operations/functions specified in the flowchart block or blocks.

These computer instructions may also be stored in a computer usable or computer-readable medium, e.g., a memory, that can direct a computer or other programmable data processing apparatus to operate in a particular manner, such that the instructions in the computer usable or computer-readable memory produce an article of manufacture including instructions that implement the operation/function specified in the flowchart block or blocks.

The computer instructions may also be loaded onto a computer or other programmable data processing apparatus to cause a series of operations to be performed on the computer or other programmable apparatus to produce a computer implemented process such that the instructions that execute on the computer or other programmable apparatus implement the operations/functions specified in the flowchart block or blocks.

Further, each block of the block diagram and flowchart illustrations may also represent a module, segment, or portion of code, which may include one or more executable instructions for implementing the specified logical operation(s). It should also be noted that in some alternative implementations, the operations/functions noted in the blocks may occur in alternate order. For example, two blocks shown in succession may in fact be executed substantially concurrently or the blocks may sometimes be executed in alternate order, depending upon the functionality involved.

Accordingly, although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An apparatus controlling an audio output and/or a video output, comprising:
an input device interface module to receive content including video information and audio information corresponding to the video information;
a user interface module to provide a user interface to enable a user to select at least one output device for receipt of the audio information and at least one output device for receipt of the video information, and to enable a user to select the at least one output device for receipt of the audio information or the at least one output device for receipt of the video information;
a control module to receive the content from the input device interface module and output to an output device interface module a command to transmit the audio information and/or the video information to a respective selected output device; and
an output device interface module to receive the command from the control module and transmit the audio information and/or the video information to each selected output devices, respectively.

2. The apparatus of claim 1, wherein the output device interface module transmits state information of output devices to the control module, the control module transmits the state information to the user interface module, and the user interface module displays output devices that can be selected by the user in the user interface.

3. The apparatus of claim 1, further comprising a storage module to store mapping information between output devices for outputting the video information and output devices for outputting the audio information,
wherein the control module extracts mapping information corresponding to the at least one output device selected by the user from the storage module and outputs a command corresponding to the extracted mapping information.

4. The apparatus of claim 1, wherein the at least one output device for receipt of the video information comprises a digital display device that receives the video information and the audio information from the output device interface module via a single cable.

5. The apparatus of claim 4, wherein the cable is a medium supporting a high definition multimedia interface (HDMI) standard.

6. The apparatus of claim 5, wherein the digital display device comprises an integrated circuit chipset supporting the HDMI standard, and electrical power supplied to the integrated circuit chipset is interrupted when the integrated circuit chipset does not receive video and/or audio information via the cable for a predetermined period of time.

7. The apparatus of claim 5, wherein the digital display device comprises an integrated circuit chipset supporting the HDMI standard, and electrical power supplied to the digital display device is interrupted when the integrated circuit chipset does not receive any video and/or audio information via the cable for a predetermined period of time.

8. The apparatus of claim 1, wherein the output device interface module is in an off-state in an initial start-up stage of the apparatus.

9. The apparatus of claim 8, wherein the output device interface module is turned on when the apparatus senses that the output device interface module has been connected with any output device via a cable.

10. The apparatus of claim 9, wherein the output device interface module senses the connection with the output device via the cable based on a change in a resistance value which occurs when the cable is connected to the output device interface module.

11. The apparatus of claim 9, wherein the output device interface module supports a high definition multimedia interface (HDMI) standard.

12. A method of controlling an audio output and/or a video output, comprising:
receiving content including video information and audio information corresponding to the video information;
providing a user interface comprising a first section including a list of audio output devices to enable at least one audio output device for receipt of the audio information to be selected, a second section including a list of video output devices to enable at least one video output device for receipt of the video information to be selected, and a third section including a control input to enable initiation of the audio information to be transmitted to the selected audio output device and to enable initiation of the video information to be transmitted to the selected video output device;
enabling a user to select the at least one audio output device in the first section;
enabling the user to select the at least one video output device in the second section; and
transmitting the audio information to the at least one selected audio output device and/or the video information to the at least one selected video output device.

13. The method of claim 12, wherein the transmitting of the audio information and video information comprises transmitting the audio information and the video information via a single cable

14. The method of claim 13, wherein the single cable is a medium supporting a high definition multimedia interface (HDMI) standard.

15. The method of claim 12, wherein the audio output device is enabled to be selected in the first section when the audio output device is connected to the apparatus and is in a state enabling receipt of the audio information.

16. The method of claim 12, wherein the video output device is enabled to be selected in the second section when the video output device is connected to the apparatus and is in a state enabling receipt of the video information.

17. The method of claim 12, wherein the video output device enabled to be selected in the second section is compatible with a previously selected video output device and can receive the video information.

18. The method of claim 12, wherein the video output device includes a high definition digital television.

19. The method of claim 12, wherein the video output device supports a high definition multimedia interface (HDMI) standard.

20. The method of claim 12, wherein the second section includes a list of video output devices to enable the at least one video output device to be selected.

21. A method for controlling an audio output and/or a video output, comprising:
receiving content including video information and audio information corresponding to the video information;
enabling a user to select at least one output device for receipt of the audio information and at least one output device for receipt of the video information, and enabling a user to select at the least one output device for receipt of the audio information or the at least one output device for receipt of the video information; and
transmitting the audio information and/or the video information to each selected output devices, respectively.

22. A system controlling an audio output and/or a video output, comprising:
an input device interface module to receive content including video information and audio information corresponding to the video information;
a plurality of output devices to display the video information and/or audibly reproduce the audio information;
a user interface module to provide a user interface to enable a user to select at least one output device, of the plurality of output devices, for receipt of the audio information and at least one output device, of the plurality of output devices, for receipt of the video information, and to enable a user to select the at least one output device for receipt of the audio information or the at least one output device for receipt of the video information;
a control module to receive the content from the input device interface module and output to an output device interface module a command to transmit the audio information and/or the video information to a respective selected output device; and
an output device interface module to receive the command from the control module and transmit the audio information and/or the video information to each selected output devices, respectively.

23. The system of claim 22, wherein the at least one output device for receipt of the audio information and the at least one output device for receipt of the video information are the same output device.

24. The system of claim 22, wherein the at least one output device for receipt of the audio information and/or the at least one output device for receipt of the video information are physically separate from the user interface module.

25. At least one medium comprising computer instructions implementing the method of claim 12.

26. At least one medium comprising computer instructions implementing the method of claim 21.
